(19) United States
(12) Patent Application Publication
(10) Pub. No.: US 2026/0238151 A1
(43) Pub. Date: Aug. 13, 2026

(54) SEMICONDUCTOR DEVICE AND MOTOR CONTROL PROGRAM

(71) Applicant: Renesas Electronics Corporation, Tokyo (JP)

(72) Inventors: Che WEI, Tokyo (JP); Hiroyuki KOKUBUN, Tokyo (JP)

(21) Appl. No.: 19/399,843

(22) Filed: Nov. 25, 2025

(30) Foreign Application Priority Data
Dec. 19, 2024 (JP) 2024-224261

(51) Int. Cl. H02P 21/18; H02P 21/04

(52) U.S. Cl. CPC H02P 21/18; H02P 21/04

(57) ABSTRACT

A speed detector receives a Hall signal, and calculates, each time toggling of the Hall signal occurs, a first speed detection value based on a toggle time interval. A speed correction circuit calculates a second speed detection value by correcting the first speed detection value in a decelerating direction during a correction period. The correction period is a period from when the elapsed time from toggling of the Hall signal occurs exceeds the reference time until next toggling of the Hall signal occurs when the toggle time interval based on the first speed detection value at present is set as a reference time. A speed controller calculates a torque command value of a motor based on a speed deviation between the second speed detection value and a preset speed command value.

### CROSS-REFERENCE TO RELATED APPLICATIONS

The disclosure of Japanese Patent Application No. 2024-224261 filed on Dec. 19, 2024 including the specification, drawings and abstract is incorporated herein by reference in its entirety.

### BACKGROUND

The present invention relates to a semiconductor device and a motor control program, and more particularly to a control technique of a motor provided with a Hall sensor.

There are disclosed techniques listed below.
[Patent Document 1] Japanese Unexamined Patent Application Publication No. 2009-83710

Patent Document 1 illustrates a motor control device capable of easily or efficiently implementing high functionality. The motor control device includes, in addition to a PWM controller that controls an inverter using a PWM signal, an FV converter. The FV converter receives a frequency signal from a Hall sensor of the motor, counts a period of the frequency signal, calculates a reciprocal thereof, and converts a result of the calculation into an analog voltage. The FV converter outputs the analog voltage, namely a speed voltage signal proportional to the frequency, to an external speed meter.

### SUMMARY

For example, as illustrated in Patent Document 1, a motor provided with a Hall sensor is widely used. In general, the Hall sensor has low resolution of position detection, for example, in units of 60 [deg]. Therefore, in many cases, a 120 [deg] energization method is applied to the motor provided with the Hall sensor. When the 120 [deg] energization method is used, a conduction direction can be switched in synchronization with a Hall signal from the Hall sensor. Accordingly, an easy and inexpensive motor driving method can be implemented.

On the other hand, in the 120 [deg] energization method based on such a Hall sensor, there are some disadvantages such as large noise and low power efficiency. Therefore, by utilizing the Hall signal from the Hall sensor for vector control, it is expected that characteristics and efficiency will be improved. However, when the Hall signal is merely utilized for the vector control, there is a possibility that stalling of the motor occurs during low-speed operation. Therefore, some countermeasures have been required, for example, defining a lower limit value of operation guarantee in motor speed to a relatively high value.

The embodiment described later has been made in view of such circumstances, and other problems and novel features will become apparent from the description of the present specification and the accompanying drawings.

According to one embodiment, a semiconductor device outputs a motor control signal to an inverter that supplies power to a motor, and controls the motor via the inverter. A Hall sensor that toggles a Hall signal when a rotation angle of the motor reaches a predetermined rotation angle is attached to the motor. Here, the semiconductor device includes a speed detector, a speed correction circuit, and a speed controller. A speed detector receives a Hall signal, and calculates, each time toggling of the Hall signal occurs, a first speed detection value representing a rotational speed of the motor based on a toggle time interval. A speed correction circuit calculates a second speed detection value by correcting the first speed detection value in a decelerating direction during a correction period. The correction period is a period from when the elapsed time from toggling of the Hall signal occurs exceeds the reference time until the next toggling of the Hall signal occurs when the toggle time interval based on the first speed detection value at present is set as a reference time. A speed controller calculates a torque command value of a motor based on a speed deviation between the second speed detection value and a preset speed command value.

According to the embodiment, a stall of the motor during low-speed rotation can be prevented.

### BRIEF DESCRIPTION OF THE DRAWINGS

FIG. 1 is a schematic diagram illustrating a configuration example of a motor system to which a semiconductor device according to an embodiment is applied.

FIG. 2A is a schematic diagram illustrating a configuration example of a motor and Hall sensors in FIG. 1.

FIG. 2B is a timing chart illustrating an example of Hall signals output from respective Hall sensors in FIG. 2A.

FIG. 3 is a block diagram illustrating a detailed configuration example of the semiconductor device in FIG. 1.

FIG. 4 is a circuit block diagram illustrating a configuration example of a rotation angle/speed estimator in FIG. 3.

FIG. 5 is a timing chart illustrating an operation example of a speed detector in FIG. 4.

FIG. 6 is a timing chart illustrating operation examples of the rotation angle/speed estimator and a speed controller illustrated in FIG. 4.

FIG. 7 is a circuit block diagram illustrating a configuration example of a rotation angle/speed estimator as a comparative example.

FIG. 8 is a timing chart illustrating operation examples of the rotation angle/speed estimator and the speed controller illustrated in FIG. 7.

### DETAILED DESCRIPTION

In the following embodiment, for convenience, descriptions will be divided into a plurality of sections or embodiments when necessary. However, unless otherwise explicitly stated, they are not unrelated to each other, and one has a relationship such as a modification, detail, or supplementary description of a part or all of the other. Further, when referring to the number of elements (including the number, numerical values, amounts, ranges, and the like), unless otherwise explicitly stated or unless it is apparent in principle that the number is limited to a specific number, the number is not limited to that specific number. That is, the number of elements may be greater or less than the specific number.

Furthermore, in the following embodiment, the constituent elements (including element steps) are not necessarily essential unless otherwise explicitly stated or unless it is apparent in principle that they are essential. Similarly, when referring to shapes, positional relationships, and the like of constituent elements, unless otherwise explicitly stated or unless it is apparent in principle that they are not so, such descriptions include those substantially approximating or similar to the shapes and the like. The same applies to the above-mentioned numerical values and ranges.

In addition, circuit elements constituting each functional block of the embodiment are not particularly limited, but may be formed, for example, on a semiconductor substrate such as single-crystal silicon by a known integrated circuit technology of Complementary Metal Oxide Semiconductor (CMOS). Hereinafter, embodiment of the present invention will be described in detail referring to the drawings. In all drawings for illustrating the embodiments, the same reference numerals are given to the same members in principle, and repeated descriptions thereof are omitted.

### Outline of Motor System

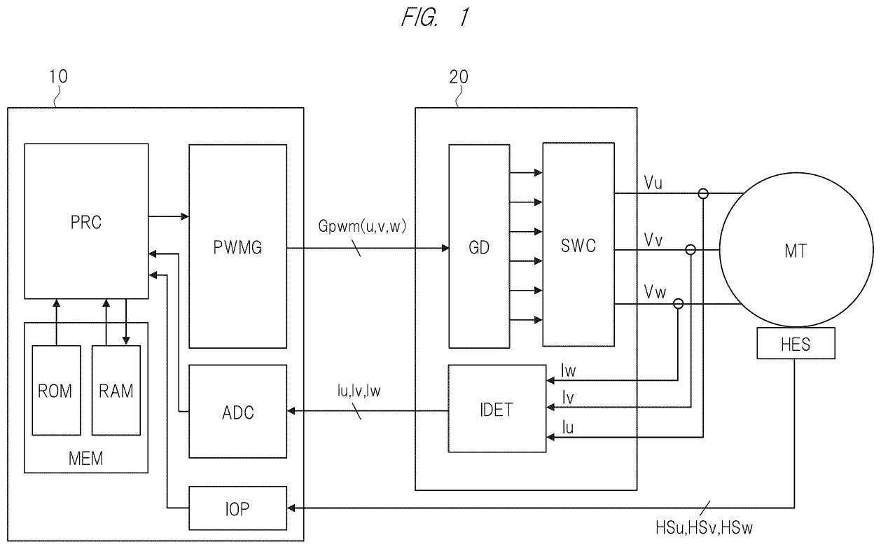

FIG. 1 is a schematic diagram illustrating a configuration example of a motor system to which a semiconductor device according to an embodiment is applied. The motor system illustrated in FIG. 1 includes a semiconductor device 10, an inverter 20, and a motor MT. The motor MT is, for example, a three-phase motor including a u phase, a v phase, and a w phase. A Hall sensor HES, specifically a Hall sensor IC including a Hall sensor and a comparator located downstream thereof, is attached to the motor MT.

The Hall sensor HES toggles a Hall signal when a rotation angle of the motor MT reaches a predetermined rotation angle. In this example, the Hall sensor HES toggles three-phase Hall signals HSu, HSv, and HSw. In the present specification, the three-phase Hall signals HSu, HSv, and HSw are collectively referred to as a Hall signal HS.

The semiconductor device 10 generates and outputs a motor control signal for controlling the motor MT, for example, a Pulse Width Modulation (PWM) signal Gpwm. In this example, the semiconductor device 10 is a microcontroller or a system on chip (SoC) configured of a single semiconductor chip. The semiconductor device 10 mainly includes a processor PRC, a memory MEM, a PWM signal generator PWMG, an analog-to-digital converter ADC, and an IO port IOP.

The processor PRC is, for example, a Central Processing Unit (CPU) or a Digital Signal Processor (DSP). The memory MEM includes a Read Only Memory (ROM) and a Random Access Memory (RAM). The ROM is, for example, a flash memory. The RAM is, for example, an SRAM or a DRAM. The ROM stores a motor control program. The motor control program is copied into the RAM. The processor PRC controls the motor MT by executing the motor control program copied into the RAM.

The PWM signal generator PWMG generates, for example, a PWM signal Gpwm(u, v, w) for each phase based on a duty ratio command value for each phase from the processor PRC. The analog-to-digital converter ADC receives, via the inverter 20, a detection signal representing a state of the motor MT, in this example, a detection signal representing a phase current of the motor MT. The analog-to-digital converter ADC converts the detection signal into a digital value. The I/O port IOP receives a Hall signal HS from the Hall sensor HES. The processor PRC determines the duty ratio command value for each phase based on information on the phase current of the motor MT and information on the Hall signal HS.

The inverter 20 supplies AC power to each phase of the motor MT based on a motor control signal from the semiconductor device 10, specifically, from the PWM signal generator PWMG. The inverter 20 includes a gate driver GD, a switching circuit SWC, and a current detector IDET. The switching circuit SWC is configured, for example, as a three-phase bridge circuit including six switching elements.

The gate driver GD receives a PWM signal Gpwm(u, v, w) for each phase from the semiconductor device 10. Then, the gate driver GD controls on/off of the six switching elements in the switching circuit SWC based on the received PWM signal Gpwm(u, v, w). Accordingly, the switching circuit SWC supplies three-phase phase voltages Vu, Vv, and Vw, corresponding to a duty ratio of the PWM signal, to the motor MT.

The current detector IDET detects three-phase phase currents Iu, Iv, and Iw flowing through the motor MT. The analog-to-digital converter ADC in the semiconductor device 10 converts the three-phase phase currents Iu, Iv, and Iw detected by the current detector IDET into digital values. Note that the current detector IDET may detect at least phase currents for two phases, not limited to three phases. In this case, a value of a remaining phase current for one phase may be calculated.

Further, the current detector IDET may detect the three-phase phase currents Iu, Iv, and Iw by detecting, for example, a power supply current of the switching circuit SWC. In this case, the current detector IDET recognizes on/off states of the six switching elements based on, for example, the PWM signal Gpwm(u, v, w). Then, the current detector IDET detects corresponding phase currents based on the recognized combination of ON/OFF states.

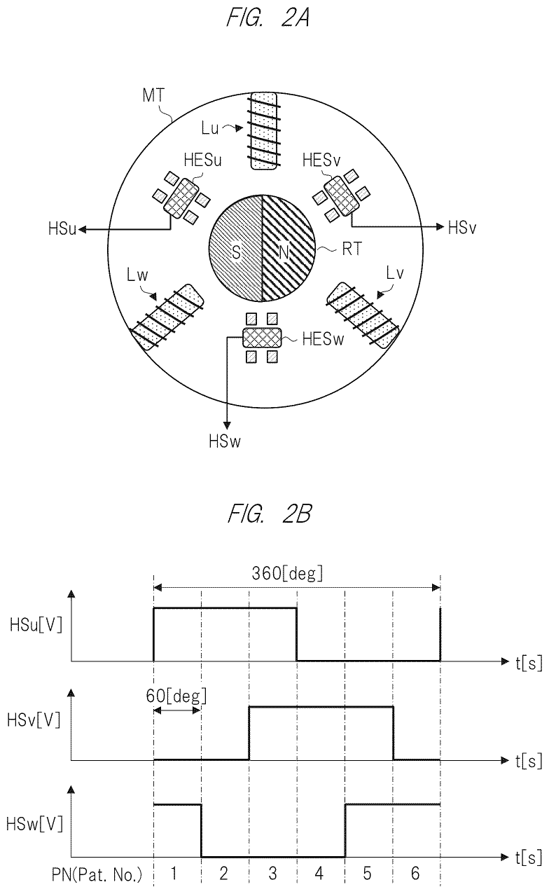

FIG. 2A is a schematic diagram illustrating a configuration example of the motor MT and the Hall sensors HES in FIG. 1. FIG. 2B is a timing chart illustrating an example of Hall signals output from the respective Hall sensors HES in FIG. 2A. The motor MT illustrated in FIG. 2A includes three-phase coils Lu, Lv, and Lw wound around three stators, respectively, and a rotor RT formed of a permanent magnet. Three Hall sensors HESu, HESv, and HESw are attached to the motor MT at intervals of 120 [deg].

The three Hall sensors HESu, HESv, and HESw, specifically Hall sensor ICs, respectively output three-phase Hall signals HSu, HSv, and HSw in accordance with magnetic pole positions of the rotor RT. As illustrated in FIG. 2B, the three-phase Hall signals HSu, HSv, and HSw are different in phase from one another by 120 [deg]. A combination of logic levels of the three-phase Hall signals HSu, HSv, and HSw forms six patterns. In the present specification, the six patterns are distinguished by six pattern numbers PN. The pattern number PN switches every 60 [deg]. In other words, toggling of the Hall signal HS occurs every 60 [deg].

### Details of Semiconductor Device

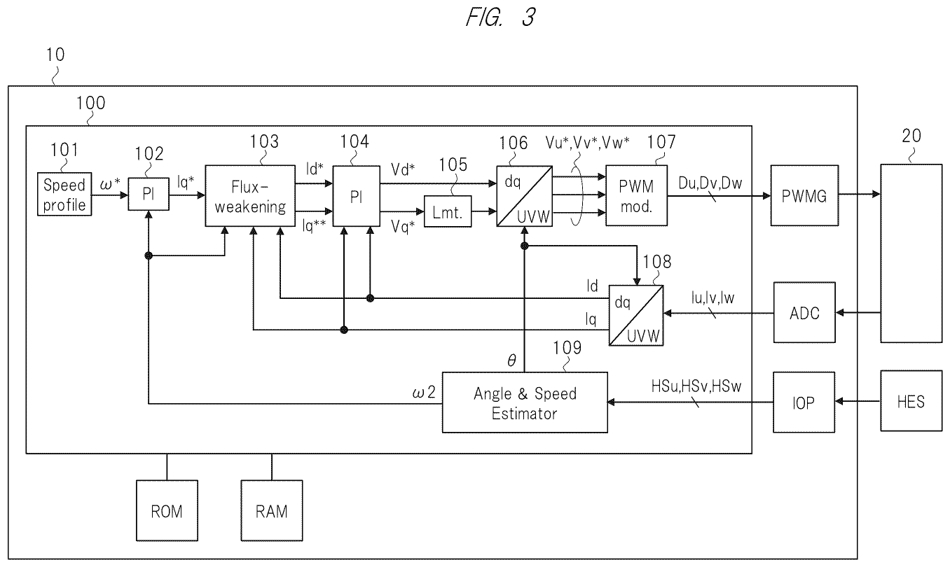

FIG. 3 is a block diagram illustrating a detailed configuration example of the semiconductor device 10 in FIG. 1. The semiconductor device 10 illustrated in FIG. 3 includes a motor controller 100 in addition to the PWM signal generator PWMG, the analog-to-digital converter ADC, the I/O port IOP, the RAM, and the ROM illustrated in FIG. 1. The motor controller 100 is implemented by the processor PRC illustrated in FIG. 1 executing the motor control program stored in the RAM. In other words, the motor control program causes the processor PRC to function as respective constituent elements in the motor controller 100 illustrated in FIG. 1.

The motor controller 100 performs vector control with sensors based on three-phase Hall signals HSu, HSv, and HSw from the I/O port IOP. The motor controller 100 includes a speed command unit 101, a speed controller 102, a field-weakening controller 103, a current controller 104, and a command value limiting circuit 105. The motor controller 100 also includes a two-axis/three-axis converter 106, a PWM signal modulator 107, and a three-axis/two-axis converter 108. Furthermore, the motor controller 100 includes a rotation angle/speed estimator 109.

Details will be described later, but the rotation angle/speed estimator 109 calculates a speed detection value ω2 representing a rotation speed of the motor MT based on three-phase Hall signals HSu, HSv, and HSw. The rotation angle/speed estimator 109 also calculates a rotation angle θ of the motor MT varying over time based on the calculated speed detection value ω2.

The three-axis/two-axis converter 108 receives three-phase phase currents Iu, Iv, and Iw from the analog-to-digital converter ADC, and the rotation angle θ from the rotation angle/speed estimator 109. Then, the three-axis/two-axis converter 108 converts the three-phase phase currents Iu, Iv, and Iw into a d-axis current Id and a q-axis current Iq of the two-axis coordinate system by a Clarke transformation and a Park transformation using the rotation angle θ. The three-phase phase currents Iu, Iv, and Iw are currents in UVW coordinates, which are rotational coordinates. On the other hand, the d-axis current Id and the q-axis current Iq of the two-axis coordinate system are currents in dq coordinates, which are fixed coordinates.

The speed command unit 101 generates a speed command value ω* based on, for example, a predetermined speed profile. The speed controller 102 performs, for example, PI (Proportional-Integral) control based on a speed deviation between the speed command value ω* and the speed detection value ω2 from the rotation angle/speed estimator 109. Accordingly, the speed controller 102 generates a q-axis current command value Iq*, in other words, a torque command value, for reducing the speed deviation toward zero.

The field-weakening controller 103 receives the q-axis current command value Iq* from the speed controller 102, the speed detection value ω2 from the rotation angle/speed estimator 109, and the d-axis current Id and the q-axis current Iq from the three-axis/two-axis converter 108. Then, the field-weakening controller 103 generates and outputs a d-axis current command value Id* in addition to a new q-axis current command value Iq**. The field-weakening controller 103 performs control to weaken a magnetic field generated by the rotor RT in order to reduce an induced voltage of the motor MT and thereby increase an upper limit value of a rotation speed of the motor MT. At this point, the field-weakening controller 103 weakens the magnetic field generated by the rotor RT mainly by controlling the d-axis current command value Id*.

The current controller 104 receives the d-axis current command value Id* and the q-axis current command value Iq** from the field-weakening controller 103. The current controller 104 performs, for example, PI control based on a current deviation between the d-axis current command value Id* and the d-axis current Id from the three-axis/two-axis converter 108, and a current deviation between the q-axis current command value Iq** and the q-axis current Iq from the three-axis/two-axis converter 108. Accordingly, the current controller 104 generates a d-axis voltage command value Vd* and a q-axis voltage command value Vq* to reduce the current deviations toward zero. The command value limiting circuit 105 limits, for example, the upper limit of the q-axis voltage command value Vq*.

The two-axis/three-axis converter 106 receives the d-axis voltage command value Vd* from the current controller 104, and the q-axis voltage command value Vq* from the current controller 104 via the command value limiting circuit 105. The two-axis/three-axis converter 106 also receives a rotation angle θ from the rotation angle/speed estimator 109. By an inverse Park transform and an inverse Clarke transform using the rotation angle θ, the two-axis/three-axis converter 106 converts the d-axis voltage command value Vd* and q-axis voltage command value Vq* of the two-axis coordinate system into three-phase voltage command values Vu*, Vv*, and Vw*. The PWM signal modulator 107 converts the three-phase voltage command values Vu*, Vv*, and Vw* into three-phase duty-ratio command values Du, Dv, and Dw, and outputs them to a PWM signal generator PWMG.

Here, the motor controller 100 is implemented by program processing using the processor PRC. However, the motor controller 100 may be implemented by using, for example, a Field Programmable Gate Array (FPGA) or an Application Specific Integrated Circuit (ASIC) or the like. That is, the semiconductor device 10 illustrated in FIG. 1 may be an FPGA, an ASIC, or the like.

### Details of Rotation Angle/speed Estimator

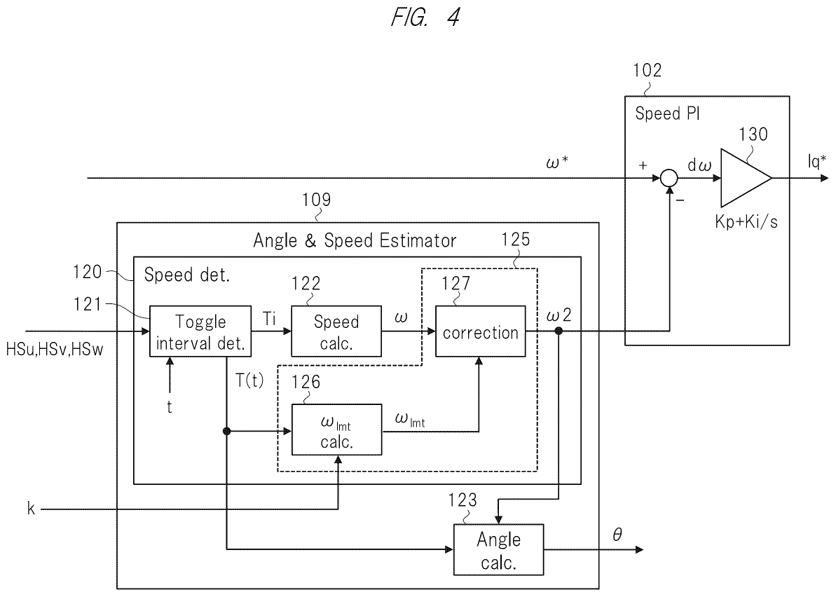

FIG. 4 is a circuit block diagram illustrating a configuration example of the rotation angle/speed estimator 109 in FIG. 3. In FIG. 4, in addition to the rotation angle/speed estimator 109, a configuration example of the speed controller 102 is also illustrated. The rotation angle/speed estimator 109 illustrated in FIG. 4 includes a speed detector 120 and a rotation angle calculation circuit 123. The speed detector 120 includes a speed correction circuit 125 in addition to a toggle interval detector 121, a speed calculation circuit 122.

The toggle interval detector 121 receives three-phase Hall signals HSu, HSv, and HSw, and time t. Time t is, for example, software time and may be an interrupt signal generated at fixed intervals. The toggle interval detector 121 detects and outputs a toggle time interval Ti each time toggling of the Hall signal HS occurs, based on the time t. Furthermore, the toggle interval detector 121 outputs elapsed time T(t) from when the toggling of the Hall signal HS occurs, each time the toggle occurs.

The speed calculation circuit 122 calculates a speed detection value (first speed detection value) ω representing a rotation speed of the motor MT, based on the toggle time interval Ti from the toggle interval detector 121. The speed correction circuit 125, details of which will be described later, corrects the speed detection value ω from the speed calculation circuit 122 to calculate and output a corrected speed detection value (second speed detection value) ω2. The rotation angle calculation circuit 123 calculates a rotation angle θ of the motor MT based on the corrected speed detection value ω2 and the elapsed time T(t) from the toggle interval detector 121.

The speed controller 102 calculates a speed deviation dω between a speed detection value from the rotation angle/speed estimator 109, here that is ω2, and a preset speed command value ω*. The speed controller 102 then calculates a torque command value of the motor MT by performing PI control using, for example, a PI controller 130, based on the speed deviation dω. The torque command value of the motor MT corresponds to the q-axis current command value Iq*. Also, the PI controller 130 performs PI control using the proportional gain Kp and the integral gain Ki.

### Rotation Angle/Speed Estimator (Comparative Example) and Problems Thereof

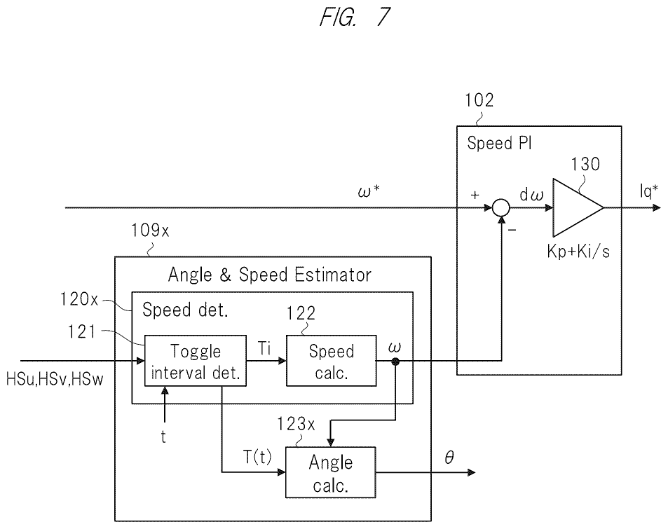

FIG. 7 is a circuit block diagram illustrating a configuration example of a rotation angle/speed estimator 109x as a comparative example. The rotation angle/speed estimator 109x illustrated in FIG. 7 includes a speed detector 120x and a rotation angle calculation circuit 123x, which are different from those in FIG. 4. Unlike the speed detector 120 illustrated in FIG. 4, the speed detector 120x is not provided with the speed correction circuit 125. Accordingly, the rotation angle/speed estimator 109x outputs a speed detection value ω from the speed calculation circuit 122 to the speed controller 102. The rotation angle calculation circuit 123x also calculates a rotation angle θ of the motor MT based on the uncorrected speed detection value ω from the speed calculation circuit 122 and the elapsed time T(t) from the toggle interval detector 121.

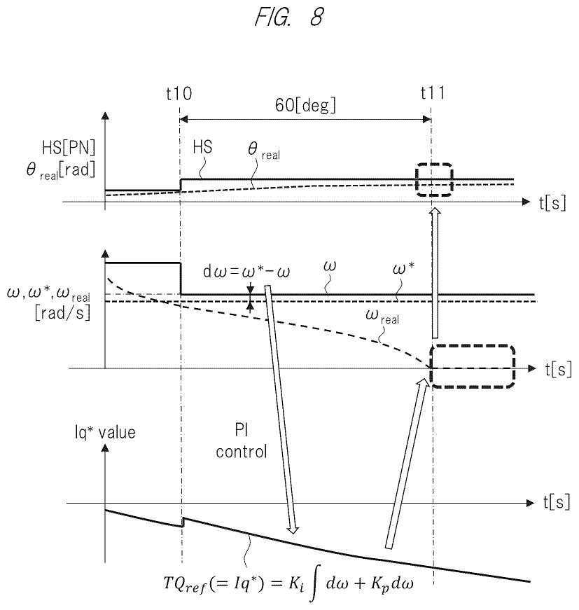

FIG. 8 is a timing chart illustrating an operation example of the rotation angle/speed estimator 109x and the speed controller 102 illustrated in FIG. 7. In FIG. 8, a pattern number PN of a Hall signal HS and a time-series transition of an actual rotation angle θᵣₑₐₗ [rad] of the motor MT are illustrated. Also illustrated are time-series transitions of a speed detection value ω [rad/s], a speed command value ω* [rad/s], and an actual speed value ωᵣₑₐₗ [rad/s] of the motor MT. Furthermore, a time-series transition of a q-axis current command value Iq*, which is a torque command value TQ_{ref}, is illustrated.

Here, it is assumed that the motor MT is in a state of low-speed rotation and that the motor MT is decelerating. The speed command value ω* is a constant value representing a low-speed rotation value. At the time t10, toggling of the Hall signal HS occurs. In response, the speed calculation circuit 122 calculates a speed detection value ω, for example, based on Equation (1), using the toggle time interval Ti from the toggle interval detector 121.

Ω=Ra/ti (1)

In Equation (1), “RA” is a rotation angle of the motor MT that proceeds during the toggle time interval, and is, for example, “2π/6 [rad] (=60 [deg])”. The toggle time interval Ti is an interval between the time t10 and a toggle occurrence time immediately preceding the time t10 (not illustrated). However, not limited to Equation (1), the speed calculation circuit 122 may calculate the speed detection value ω by, for example, an average value. As a specific example, “RA” may be “2π [rad] (=360 [deg])”, and the toggle time interval Ti may be a time interval of past six occurrences.

Here, in FIG. 8, the speed detection value ω calculated at the time t10 is higher than the speed command value ω*. Based on a negative speed deviation (=ω*−ω) resulting therefrom, the speed controller 102 controls the q-axis current command value Iq*, which is the torque command value TQ_{ref}, in a direction to further decrease the value. As a result, the deceleration of the motor MT proceeds, and the actual speed value ωᵣₑₐₗ decreases. On the other hand, the speed detection value ω is maintained constant until the next toggling of the Hall signal HS is supposed to occur at the time t11. Accordingly, during a period from the time t10 to the time t11, the negative speed deviation is maintained. Thus, during the period from the time t10 to the time t11, the speed controller 102 continues to decrease the q-axis current command value Iq*, and the motor MT continues to decelerate.

Thus, particularly when the rotation speed of the motor MT is low, the motor MT may stop before reaching the time t11, that is, before rotating 60 [deg] from the time t10. In this example, the actual speed value ωᵣₑₐₗ becomes zero at the time t11. In this case, since the toggling of the Hall signal HS that is supposed to occur at the time t11 does not occur, the control operation of the motor MT also stops. As described above, in the rotation angle/speed estimator 109x as the comparative example, stalling may occur during low-speed rotation of the motor MT. Therefore, in FIG. 4, the speed correction circuit 125 is provided.

### Details of Speed Correction Circuit

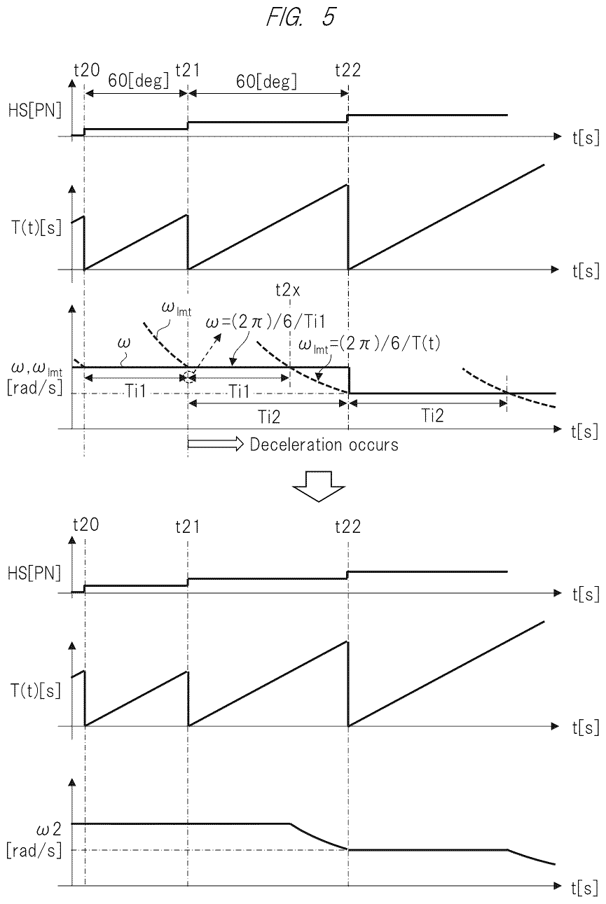

FIG. 5 is a timing chart illustrating an operation example of the speed detector 120 in FIG. 4. In FIG. 5, a time-series transition of a pattern number PN of a Hall signal HS is illustrated. Also illustrated is elapsed time T(t) [s] from the toggle interval detector 121, that is, the elapsed time T(t) from when the toggling of the Hall signal HS occurs. Furthermore, time-series transitions of the speed detection value (first speed detection value) ω [rad/s], a speed correction value ωₗₘₜ [rad/s], and the speed detection value (second speed detection value) ω2 [rad/s] are illustrated.

In FIG. 5, toggling of the Hall signal HS occurs at time t20, time t21, and time t22. In this example, it is assumed that the motor MT decelerates after the time t21. In this case, a time interval Ti2 from the time t21 to the time t22 becomes longer than a time interval Ti1 from the time t20 to the time t21.

Here, attention is focused on a period after the time t21. First, a toggle time interval Ti1, which is based on a speed detection value ω at present from the speed calculation circuit 122, is set as a reference time. The speed detection value ω after the time t21 is determined based on the time interval Ti1 from the time t20 to the time t21 in Equation (1) described above, where “RA” is 60 [deg]. In this case, the reference time after the time t21 is equal to the time interval Ti1.

Here, a period from when the elapsed time T(t) from the toggle interval detector 121 exceeds the time interval Ti1, i.e., the reference time, until the next toggling of the Hall signal HS occurs is referred to as a correction period. In this example, the correction period is a period from time t2x when the elapsed time T(t) exceeds the time interval Ti1 to the time t22 when the next toggling of the Hall signal HS occurs. The speed correction circuit 125 illustrated in FIG. 4 calculates the corrected speed detection value (second speed detection value) ω2 by correcting the speed detection value ω from the speed calculation circuit 122 in a decelerating direction during this correction period. Specifically, during this correction period, the speed correction circuit 125 corrects the speed detection value ω so as to decrease in accordance with the elapsed time T(t).

More specifically, the speed correction circuit 125 includes, for example, a correction value calculation circuit 126 and a correction execution circuit 127. The correction value calculation circuit 126 calculates a speed correction value ωₗₘₜ that decreases in inverse proportion to the elapsed time T(t) each time toggling of the Hall signal HS occurs. As a specific example, the correction value calculation circuit 126 calculates the speed correction value ωₗₘₜ based on Equation (2). In Equation (2), “k” is a coefficient set to a value of 1 or more, and is ideally “k=1”. “RA” is a rotation angle of the motor MT that proceeds during the toggle time interval, and is “2π/6 [rad] (=60 [deg])”.

ωₗₘₜ=k*(RA/T(t)) (2)

In the example illustrated in FIG. 5, during a period preceding the time t2x, the speed correction value ωₗₘₜ is greater than the speed detection value ω. On the other hand, during the correction period after the time t2x, the speed correction value ωₗₘₜ is smaller than the speed detection value ω. Therefore, the corrected speed detection value ω2 is equal to the speed detection value ω from the speed calculation circuit 122 during a period from the time t21 to the time t2x. On the other hand, the corrected speed detection value ω2 is equal to the speed correction value ωₗₘₜ during a correction period from the time t2x to the time t22.

The correction execution circuit 127 compares the speed detection value ω at present from the speed calculation circuit 122 with a speed correction value ωₗₘₜ from the correction value calculation circuit 126. The correction execution circuit 127 outputs, based on Expression (3), the smaller one of the values as a speed detection value ω2 to the speed controller 102. It should be noted that the condition “max(−ωₗₘₜ,)” in Expression (3) is a condition for applying the similar speed correction in both a case where the motor MT is rotated forward and a case where the motor MT is rotated backward.

Ω2=Max(−ωₗₘₜ, min(ωₗₘₜ, Ω)) (3)

In the period after the time t22, the similar operation as that in the period from the time t21 to the time t22 is performed. On the other hand, in a period preceding the time t21, deceleration of the motor MT does not occur. That is, the toggle time interval Ti at present is equal to, or shorter than, the previous toggle time interval Ti. In this case, the corrected speed detection value ω2 becomes equal to the uncorrected speed detection value ω.

Further, a value of a coefficient k in Expression (2) represents a control margin and, for example, is variably set arbitrarily by a user. For example, three Hall sensors HESu, HESv, and HESw illustrated in FIG. 2A may actually involve mounting errors. Therefore, an error may also occur, with reference to 60 [deg], in a rotation angle of the motor MT that proceeds during the toggle time interval Ti. The value of the coefficient k is determined, for example, in consideration of such an error. When the value of the coefficient k is set to be slightly larger than 1, the time t2 x in FIG. 5 is shifted to a delayed side by that amount.

It should be noted that a method of the speed correction circuit 125 is not necessarily limited to a method based on Expression (2) and Expression (3). That is, the speed correction circuit 125 only needs to correct a speed detection value ω from the speed calculation circuit 122 in a deceleration direction during the above-described correction period. As one example, the speed correction circuit 125 may employ a method in which the time t2x is detected based on the time interval Ti1, and from that time, the speed detection value ω is corrected in the deceleration direction based on a predetermined expression. In this case, detecting the time t2x also means detecting a deceleration of the motor MT.

However, by using the method based on Expression (2) and Expression (3) among various methods, there is an effect that the speed detection value ω from the speed calculation circuit 122 can be corrected to a reasonable value. That is, as can be seen from comparison between Expression (1) and Expression (2), the speed correction value ωₗₘₜ calculated during the period from the time t21 to the time t22 becomes equal to the speed detection value ω calculated by the speed calculation circuit 122 at the time t22. Therefore, as illustrated in FIG. 5, continuity of the corrected speed detection value ω2 is maintained at the time t22. As a result, for example, vibration of the motor MT caused by an abrupt change in the speed detection value ω2 can be suppressed.

Operation of Rotation Angle/speed Estimator (embodiment)

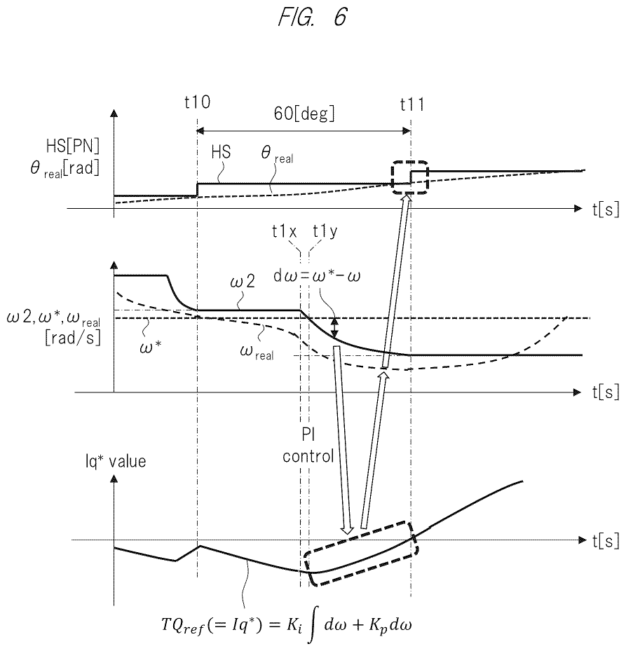

FIG. 6 is a timing chart illustrating an operation example of the rotation angle/speed estimator 109 and the speed controller 102 illustrated in FIG. 4. FIG. 6 illustrates a timing chart substantially similar to that in the case of FIG. 8. However, unlike the case of FIG. 8, the uncorrected speed detection value ω is replaced with the corrected speed detection value ω2. Accordingly, at the time t1x between the time t10 and the time t11, a decrease in the speed detection value ω2 based on the speed correction value ωₗₘₜ starts. Then, at the subsequent time t1y, the speed detection value ω2 becomes lower than the speed command value ω*.

In response, the speed controller 102, after the time t1y, continuously increases the q-axis current command value Iq*, which is the torque command value TQref, from the decreasing direction. As a result, an actual speed value ωᵣₑₐₗ of the motor MT also stops decreasing. Consequently, since rotation of 60 [deg] of the motor MT can be maintained after the time t10, the next toggling of a Hall signal HS can be generated at the time t11. In this manner, in FIG. 6, unlike in the case of the comparative example illustrated in FIG. 8, stalling of the motor MT during low-speed rotation can be prevented.

### Rotation Angle Calculation Circuit

The rotation angle calculation circuit 123 illustrated in FIG. 4 calculates a rotation angle θ of the motor MT, for example, by integrating the corrected speed detection value ω2 with the elapsed time T(t). On the other hand, the rotation angle calculation circuit 123x serving as the comparative example illustrated in FIG. 7 calculates the rotation angle θ of the motor MT by integrating the uncorrected speed detection value ω with the elapsed time T(t). Due to this difference, by using the rotation angle calculation circuit 123 according to the embodiment, an error in the rotation angle that may occur at, for example, the time t11 in FIG. 6 can be suppressed.

That is, at the time t11, an error between the rotation angle θ from the rotation angle calculation circuit 123 and an actual rotation angle θᵣₑₐₗ becomes smaller than in a case of using the rotation angle θ from the rotation angle calculation circuit 123x. It should be noted that, in practice, the calculated rotation angle θ may be limited, for example, by an upper limiter of 60 [deg] units. In this case, no particular difference occurs between a case of using the corrected speed detection value ω2 and a case of using the uncorrected speed detection value ω. However, in a case of calculating the rotation angle θ using other methods, by using the rotation angle calculation circuit 123, the error in the rotation angle can be suppressed.

### Modification

The motor controller 100 illustrated in FIG. 3 executes vector control using the torque command value from the speed controller 102 and the rotation angle θ from the rotation angle/speed estimator 109. On the other hand, the speed correction method according to the above-described embodiment is not limited to vector control and may be applied, for example, to a 120 [deg] conduction method. However, from a viewpoint of reducing noise of the motor MT and from a viewpoint of increasing power efficiency, that is, from a viewpoint of implementing a higher-performance motor system, it is more preferable that the method be applied to vector control.

### Main Effect of the Embodiment

As described above, in the method according to the embodiment, a speed correction circuit is provided that corrects, in a deceleration direction, a speed detection value that becomes constant during a predetermined period in deceleration of a motor provided with a Hall sensor, from an intermediate time point. As a result, stalling of the motor during low-speed rotation can be prevented. More specifically, stalling of the motor can be prevented during low-speed rotation and deceleration of the motor. Furthermore, by being able to prevent stalling during low-speed rotation of the motor, a lower limit value of operation guarantee in motor speed can be reduced.

As described above, the invention made by the present inventors has been specifically explained based on the embodiment; however, the present invention is not limited to the above embodiment and various modifications can be made without departing from the scope of the invention. For example, the above-described embodiment has been described in detail to clearly explain the present invention, and is not necessarily limited to having all of the configurations described. Moreover, it is possible to replace part of the configuration of one embodiment with that of another embodiment, and it is also possible to add the configuration of another embodiment to that of one embodiment. Furthermore, with respect to parts of the configuration in each embodiment, it is possible to add to, delete from, or replace them with other configurations.

Also, each unit is typically implemented by program processing using a Central Processing Unit (CPU). That is, each unit is implemented on the CPU by the CPU executing a program stored in a memory. However, the implementation form of each unit is not limited to such software and may be hardware such as an FPGA or an ASIC, for example. Alternatively, the implementation form of each unit may be a combination of software and hardware.

Further, the above-described program may be stored in a non-transitory tangible computer-readable recording medium and supplied to a computer. Examples of such recording media include magnetic recording media typified by a hard disk drive and the like, and optical recording media typified by a Digital Versatile Disc (DVD), a Blu-ray Disc and the like. In addition, examples of storage media include semiconductor memories such as a flash memory or a Solid State Drive (SSD).

What is claimed is:

1. A semiconductor device that outputs a motor control signal to an inverter that supplies power to a motor, and controls the motor via the inverter,
wherein a Hall sensor that toggles a Hall signal when a rotational angle of the motor reaches a predetermined rotational angle is attached to the motor,
the semiconductor device comprising:
a speed detector configured to receive the Hall signal, and calculate, each time toggling of the Hall signal occurs, a first speed detection value representing a rotational speed of the motor based on a toggle time interval;
when the toggle time interval based on the first speed detection value at present is set as a reference time, using an elapsed time from when the toggling of the Hall signal occurs, a speed correction circuit configured to calculate a second speed detection value by correcting the first speed detection value in a decelerating direction during a correction period from when the elapsed time exceeds the reference time until the next toggling of the Hall signal occurs; and
a speed controller configured to calculate a torque command value of the motor based on a speed deviation between the second speed detection value and a preset speed command value.

2. The semiconductor device according to claim 1,
wherein the speed correction circuit corrects the first speed detection value such that the first speed detection value decreases in accordance with the elapsed time during the correction period.

3. The semiconductor device according to claim 2,
wherein the speed correction circuit includes
a correction value calculation circuit configured to calculate a speed correction value that decreases in inverse proportion to the elapsed time each time the toggling of the Hall signal occurs, and
a correction execution circuit configured to compare the first speed detection value at present with the speed correction value, and output a smaller one of a value as the second speed detection value to the speed controller.

4. The semiconductor device according to claim 3,
wherein the speed detector calculates the first speed detection value based on “RA/Ti”, in which “Ti” represents the toggle time interval and “RA” represents a rotational angle of the motor that proceeds during the toggle time interval, and
wherein the speed correction circuit calculates the speed correction value by “k*(RA/T(t))”, in which “T(t)” represents the elapsed time and “k” represents a coefficient that is set to a value of 1 or more.

5. The semiconductor device according to claim 4,
wherein the coefficient “k” is variably set arbitrarily by a user.

6. The semiconductor device according to claim 1, further comprising
a rotation angle calculation circuit configured to calculate a rotation angle of the motor based on the second speed detection value and the elapsed time.

7. The semiconductor device according to claim 6,
wherein the semiconductor device performs vector control using the torque command value from the speed controller and the rotation angle of the motor from the rotation angle calculation circuit.

8. A motor control computer readable storage medium that outputs a motor control signal to an inverter that supplies power to a motor, and controls the motor via the inverter,
wherein a Hall sensor that toggles a Hall signal when a rotation angle of the motor reaches a predetermined rotation angle is attached to the motor, the motor control computer readable storage medium causing a computer to function as:
a speed detector configured to receive the Hall signal, and calculate, each time toggling of the Hall signal occurs, a first speed detection value representing a rotation speed of the motor based on a toggle time interval;
when the toggle time interval based on the first speed detection value at present is set as a reference time, using an elapsed time from when the toggling of the Hall signal occurs, a speed correction circuit configured to calculate a second speed detection value by correcting the first speed detection value in a decelerating direction during a correction period from when the elapsed time exceeds the reference time until next toggling of the Hall signal occurs; and
a speed controller configured to calculate a torque command value of the motor based on a speed deviation between the second speed detection value and a preset speed command value.

9. The motor control computer readable storage medium according to claim 8,
wherein the speed correction circuit corrects the first speed detection value such that the first speed detection value decreases in accordance with the elapsed time during the correction period.

10. The motor control computer readable storage medium according to claim 9,
wherein the speed correction circuit includes
a correction value calculation circuit configured to calculate a speed correction value that decreases in inverse proportion to the elapsed time each time the toggling of the Hall signal occurs, and
a correction execution circuit configured to compare the first speed detection value at present with the speed correction value, and output a smaller one of a value as the second speed detection value to the speed controller.

11. The motor control computer readable storage medium according to claim 10,
wherein the speed detector calculates the first speed detection value based on “RA/Ti,” in which “Ti” represents the toggle time interval and “RA” represents a rotational angle of the motor that proceeds during the toggle time interval, and
wherein the speed correction circuit calculates the speed correction value by “k*(RA/T(t))”, in which “T(t)” represents the elapsed time and “k” represents a coefficient that is set to a value of 1 or more.
